(19) United States
(12) Patent Application Publication
(10) Pub. No.: US 2016/0359950 A1
(43) Pub. Date: Dec. 8, 2016

(54) SYSTEMS AND METHODS FOR IMPROVED TRIVIAL FILE TRANSFER PROTOCOL

(71) Applicant: QUALCOMM Incorporated, San Diego, CA (US)

(72) Inventors: Nikhilesh Reddy, San Diego, CA (US); Richard Patrick, San Diego, CA (US); Deepthi Koratikere Sridharan, San Diego, CA (US)

(21) Appl. No.: 15/167,789

(22) Filed: May 27, 2016

Related U.S. Application Data
(60) Provisional application No. 62/169,717, filed on Jun. 2, 2015.

(51) Int. Cl. H04L 29/08

(52) U.S. Cl. CPC H04L 67/06; H04L 67/02

(57) ABSTRACT

In some embodiments a device for data transfer is provided. A device for data transfer is provided. The device comprises an electronic hardware processor. The electronic hardware processor is configured to generate a Trivial File Transfer Protocol (TFTP) Read Request (RRQ) packet requesting transfer of a file. The RRQ packet includes a parameter indicating that transmission of TFTP acknowledgement (ACK) packets are deferred until the electronic hardware processor receives the entire file. The electronic hardware processor is further configured to generate a TFTP ACK packet in response to receiving the entire file.

### CROSS REFERENCE TO RELATED APPLICATIONS

This application claims priority to U.S. Provisional Application No. 62/169,717, filed Jun. 2, 2015, and entitled “SYSTEMS AND METHODS FOR IMPROVED TRIVIAL FILE TRANSFER PROTOCOL.” The disclosure of this prior application is considered part of this application, and is hereby incorporated by reference in its entirety.

### FIELD

The present application relates generally to wired and wireless communications for data transfer, and more specifically to systems, methods, and devices for file transfer according to the Trivial File Transfer Protocol (TFTP). Certain aspects herein relate to improving the TFTP file transfer process.

### BACKGROUND

Wired and wireless communications networks are used to exchange messages among several interacting spatially-separated devices. Networks may be classified according to geographic scope, which could be, for example, a metropolitan area, a local area, or a personal area. Such networks may be designated respectively as a wide area network (WAN), metropolitan area network (MAN), local area network (LAN), or personal area network (PAN). Networks also differ according to the switching/routing technique used to interconnect the various network nodes and devices (e.g., circuit switching vs. packet switching), the type of physical media employed for transmission (e.g., wired vs. wireless), and the set of communication protocols used (e.g., Internet protocol suite, SONET (Synchronous Optical Networking), Ethernet, etc.).

The Trivial File Transfer Protocol (TFTP) is standardized by the Internet Engineering Task Force (IETF) in Request for Comments (RFC) 1350 “THE TFTP PROTOCOL (REVISION 2).” Extensions and options for TFTP are standardized in other RFCs. For example, RFC 2347 “TFTP Option Extension” provides an extension to TFTP to allow option negotiation prior to the file transfer. There is a need for TFTP to use less memory and to provide faster file transfer.

### SUMMARY

The systems, methods, and devices of this disclosure each have several aspects, no single one of which is solely responsible for its desirable attributes. Without limiting the scope of the disclosure, some aspects of the disclosure are briefly described below.

A device for data transfer is provided. The device comprises an electronic hardware processor. The electronic hardware processor is configured to generate a Trivial File Transfer Protocol (TFTP) Read Request (RRQ) packet requesting transfer of a file. The RRQ packet includes a parameter indicating that transmission of TFTP acknowledgement (ACK) packets are deferred until the electronic hardware processor receives the entire file. The electronic hardware processor is further configured to generate a TFTP ACK packet in response to receiving the entire file.

Another device for data transfer is provided. The device comprises an electronic hardware processor. The electronic hardware processor is configured to receive a Trivial File Transfer Protocol (TFTP) Read Request (RRQ) packet requesting transfer of a file. The RRQ packet includes a parameter indicating that generation of TFTP acknowledgement (ACK) packets are deferred until the entire file is received. The electronic hardware processor is further configured to generate the entire file before waiting for a TFTP ACK packet in response to the parameter.

A method for data transfer is provided. The method comprises generating, by an electronic hardware processor, a Trivial File Transfer Protocol (TFTP) Read Request (RRQ) packet requesting transfer of a file. The RRQ packet includes a parameter indicating that transmission of TFTP acknowledgement (ACK) packets are deferred until the entire file is received. The method also comprises generating, by the electronic hardware processor, a TFTP ACK packet in response to receiving the entire file.

Another method for data transfer is provided. The method comprises receiving, by an electronic hardware processor, a Trivial File Transfer Protocol (TFTP) Read Request (RRQ) packet requesting transfer of a file. The RRQ packet includes a parameter indicating that generation of TFTP acknowledgement (ACK) packets are deferred until the entire file is received. The method also comprises generating, by the electronic hardware processor, a TFTP ACK packet in response to receiving the entire file.

Another device for data transfer is provided. The device comprises a processor. The processor is configured to generate a Trivial File Transfer Protocol (TFTP) Read Request (RRQ) packet. The RRQ includes a parameter indicating an offset from a beginning of a file for reading data. The device also comprises a receiver. The receiver is configured to receive a TFTP data packet in response to the TFTP RRQ packet. The TFTP data packet comprises at least a portion of the file starting at the offset.

Another method for data transfer is also provided. The method comprises generating a TFTP RRQ. The RRQ includes a parameter indicating an offset from a beginning of a file for reading data. The method also comprises receiving a TFTP data packet in response to the TFTP RRQ packet. The TFTP data packet comprises at least a portion of the file starting at the offset.

Another device for data transfer is also provided. The device comprises a receiver configured to receive a TFTP write request (WRQ) packet. The WRQ includes a parameter indicating an offset from a beginning of a file for writing data. The receiver is also configured to receive a TFTP data packet comprising data. The device also comprises a processor configured to write the data to the file at the offset in response to receiving the TFTP WRQ packet and the TFTP data packet. The processor is further configured to write the data such that the file is not truncated.

Another device for data transfer is provided. The device comprises a receiver configured to receive a TFTP WRQ. The WRQ includes a parameter indicating to append data to an end of a file. The receiver is further configured to receive a TFTP data packet comprising data. The device also comprises a processor. The processor is configured to append the data to the end of the file in response to receiving the TFTP WRQ packet and the TFTP data packet. The processor is further configured to not truncate the file during the append operation.

Another device for data transfer is provided. The device comprises a processor configured to generate a TFTP RRQ. The RRQ includes a parameter indicating a first amount of data for limiting received data. The device also comprises a receiver a receiver configured to receive a TFTP data packet in response to the RRQ packet. The TFTP data packet comprises a second amount of data. The second amount of data is less than or equal to the first amount of data.

Another device for data transfer is provided. The device comprises a receiver configured to receive a TFTP data packet comprising data. The device also comprises a processor configured to write the data to a file. The receiver is further configured to receive a TFTP error packet. The TFTP error packet includes a parameter indicating an end of a data transfer. The TFTP error packet also instructs the processor to not truncate the file.

### BRIEF DESCRIPTION OF THE DRAWINGS

The various features illustrated in the drawings may not be drawn to scale. Accordingly, the dimensions of the various features may be arbitrarily expanded or reduced for clarity. Furthermore, dotted or dashed lines and objects may indicate optional features or be used to show organization of components. In addition, some of the drawings may not depict all of the components of a given system, method, or device. Finally, like reference numerals may be used to denote like features throughout the specification and figures.

FIG. 1 shows a communication system including Trivial File Transfer Protocol (TFTP) Clients and a TFTP Server.

FIG. 2 shows a functional block diagram of components utilized in the TFTP Client of FIG. 1.

FIG. 3 shows a functional block diagram of components utilized in the TFTP Server of FIG. 1.

FIG. 4A shows a signal flow diagram of exemplary communication between the TFTP Client and the TFTP Server including a read request (RRQ) requesting an unlimited window size option for data transfer.

FIG. 4B shows a signal flow diagram of exemplary communication between the TFTP Client and the TFTP Server including a write request (WRQ) requesting an unlimited window size option for data transfer.

FIG. 5A shows an exemplary TFTP Packet for option negotiation.

FIG. 5B shows an exemplary RRQ Packet requesting an unlimited window size option for data transfer.

FIG. 5C shows an exemplary WRQ Packet requesting an unlimited window size option for data transfer.

FIG. 6A shows a signal flow diagram of exemplary communication between the TFTP Client and the TFTP Server including an RRQ requesting a seek option for data transfer.

FIG. 6B shows a signal flow diagram of exemplary communication between the TFTP Client and the TFTP Server including a WRQ requesting a seek option for data transfer.

FIG. 6C shows a signal flow diagram of exemplary communication between the TFTP Client and the TFTP Server including an RRQ requesting a seek option for data transfer.

FIG. 6D shows a signal flow diagram of exemplary communication between the TFTP Client and the TFTP Server including a WRQ requesting a seek option for data transfer.

FIG. 7A shows an exemplary RRQ Packet including a seek option for data transfer.

FIG. 7B shows an exemplary WRQ Packet format including a seek option for data transfer.

FIG. 8 shows a signal flow diagram of exemplary communication between multiple TFTP Clients and the TFTP Server including WRQs requesting an append option for data transfer.

FIG. 9 shows an exemplary WRQ Packet including an append option for data transfer.

FIG. 10 shows a signal flow diagram of exemplary communication between the TFTP Client and the TFTP Server including an RRQ requesting an rsize option for data transfer.

FIG. 11 shows an exemplary RRQ Packet including an rsize option for the data transfer.

FIG. 12 shows a signal flow diagram of exemplary communication between multiple TFTP Clients and the TFTP Server including error packets indicating an end of transfer.

FIG. 13 shows an exemplary error packet indicating an end of transfer.

FIG. 14 shows a flow chart of an exemplary method for TFTP file transfer by the TFTP Client.

FIG. 15 shows a flow chart of an exemplary method for TFTP file transfer by a TFTP Client.

FIG. 16 shows a flow chart of an exemplary method for data transfer by a TFTP Server.

### DETAILED DESCRIPTION

Various aspects of the novel systems, apparatuses, and methods are described more fully hereinafter with reference to the accompanying drawings. The teachings disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect disclosed herein may be embodied by one or more elements of a claim.

Furthermore, although particular aspects are described herein, many variations and permutations of these aspects fall within the scope of the disclosure. In addition, the scope of the disclosure is not intended to be limited to particular the benefits, uses, or objectives disclosed herein. Rather, aspects of the disclosure are intended to be broadly applicable to different wired and wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

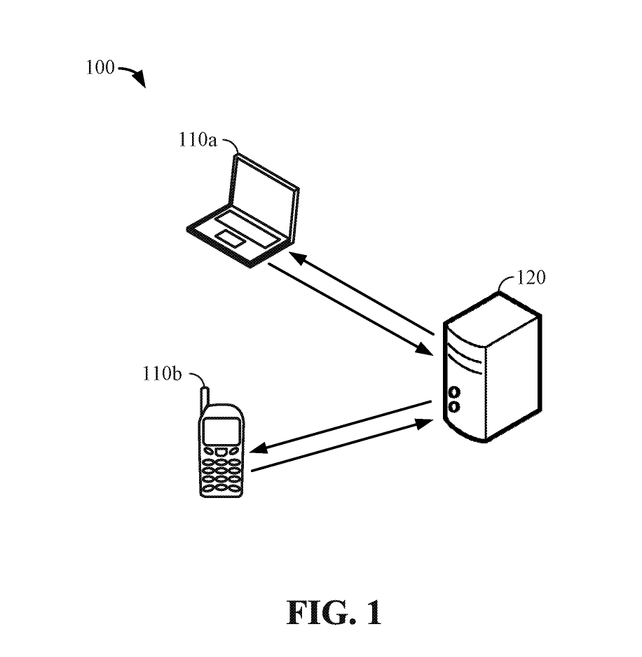

FIG. 1 shows a communication system 100 including Trivial File Transfer Protocol (TFTP) Clients 110a and 110b and a TFTP Server 120. The communication system 100 may be wired or wireless. In this embodiment, the first TFTP Client 110a comprises a laptop computer, the second TFTP Client 110b comprises a mobile phone, and the TFTP Server 120 comprises a desktop computer. In other embodiments, either the TFTP Client 110 or the TFTP Server 120 may comprise laptop computer, a desktop computer, a mobile phone (e.g., a smart phone), a portable communication device, a portable computing device (e.g., a personal data assistant), an entertainment device (e.g., a music or video device, or a satellite radio), a gaming device or system, a global positioning system device, or any other suitable device.

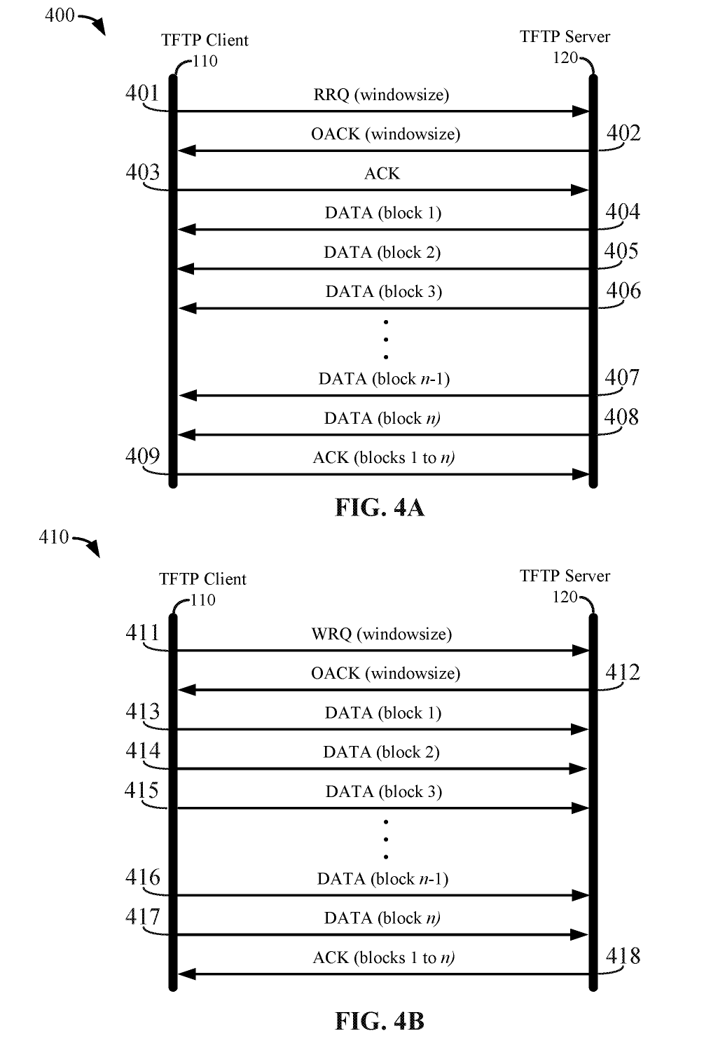

The TFTP Clients 110a and 110b are configured to communicate with the TFTP Server 120, as indicated by the arrows in FIG. 1. The TFTP Clients 110 and the TFTP Server 120 are configured to communication according to the TFTP standard. TFTP is standardized by the Internet Engineering Task Force (IETF) in Request for Comments (RFC) 1350 “THE TFTP PROTOCOL (REVISION 2).” TFTP is implemented on top of the User Datagram Protocol (UPD)/Internet Protocol (IP). Since UDP does not provide reliable communication, TFTP typically enforces a lock-step approach. In this approach, the TFTP Client 110 transmits a request to the TFTP Server 120 to read a file stored on a TFTP Server 120 or to write to a file for storing on the TFTP Server 120. Then the TFTP Client 110/Server 120 sends an acknowledgement of the request and transmits blocks of data of the file. Then the TFTP Client 110/Server 120 transmits acknowledgements for each block of data before the other of TFTP Client 110/Server 120 transmits the next block of data. Examples of TFTP communication are provided below in connection with FIGS. 4A, 4B, 6A, 6B, 8, 10, and 12.

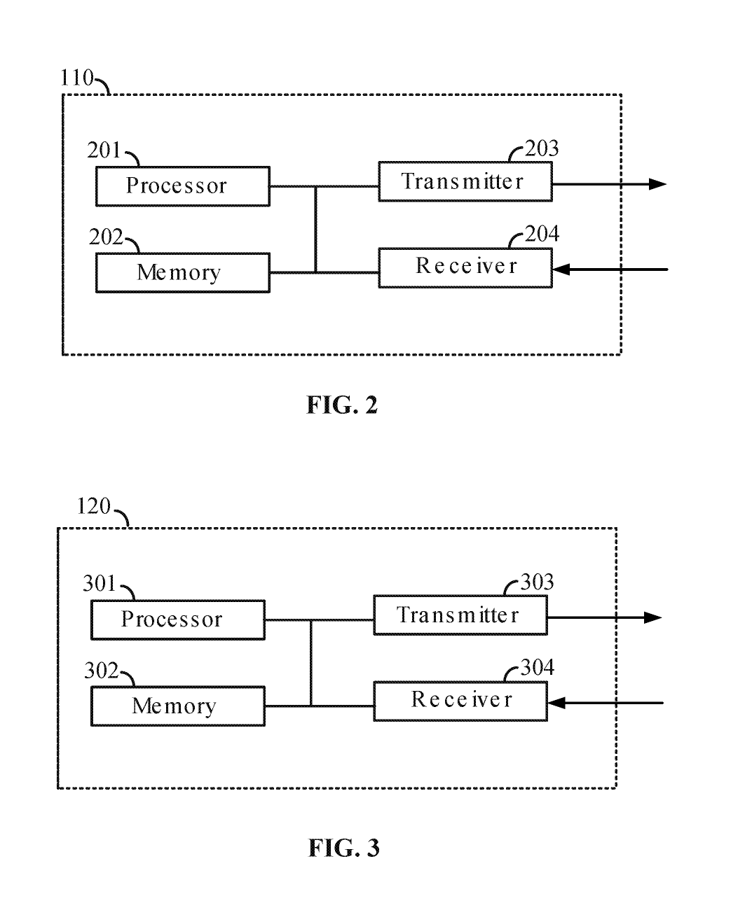

FIG. 2 shows a functional block diagram of components utilized in the TFTP Client 110 of FIG. 1. The TFTP Client 110 comprises a Processor 201. The Processor 201 controls operation of the TFTP Client 110. The Processor 201 may comprise or be a component of a processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information. The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform data transfer and other operations as described herein.

The TFTP Client 110 also comprises a Memory Unit 202. The Memory Unit 202 is configured to store information (e.g., data). The Memory Unit 202 may comprise both read-only memory (ROM) and random access memory (RAM). The Memory Unit 202 may also comprise non-volatile random access memory (NVRAM). The Memory Unit 202 provides instructions and data to the Processor 201. As described above, the Processor 201 is configured to execute the instructions to perform data transfer and other operations as described herein.

The TFTP Client 110 also comprises a Transmitter 203 and a Receiver 204 respectively configured to provide transmission and reception of data between the TFTP Client 110 and the TFTP Server 120. The Transmitter 203 and the Receiver 204 may be configured for wired or wireless communication. The TFTP Client 110 may also include multiple transmitters and multiple receivers (not shown).

The various components of the TFTP Client 110 are operably coupled to one another to provide information transfer. Although a number of separate components are illustrated in FIG. 2, one or more of the components may be combined or commonly implemented. Further, each of the components illustrated in FIG. 2 may be implemented using a plurality of separate elements.

FIG. 3 shows a functional block diagram of components utilized in the TFTP Server 120 of FIG. 1. The components of the TFTP Server 120 are configured similar to the components of the TFTP Client 110. The TFTP Server 120 comprises a Processor 301. The Processor 301 controls operation of the TFTP Server 120. The Processor 301 may comprise or be a component of a processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information. The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform data transfer and other operations as described herein.

The TFTP Server 120 also comprises a Memory Unit 302. The Memory Unit 302 is configured to store information (e.g., data). The Memory Unit 302 may comprise both read-only memory (ROM) and random access memory (RAM). The Memory Unit 302 may also comprise non-volatile random access memory (NVRAM). The Memory Unit 302 provides instructions and data to the Processor 301. As described above, the Processor 301 is configured to execute the instructions to perform data transfer and other operations as described herein.

The TFTP Server 120 also comprises a Transmitter 303 and a Receiver 304 respectively configured to provide transmission and reception of data between the TFTP Client 110 and the TFTP Server 120. The Transmitter 303 and the Receiver 304 may be configured for wired or wireless communication. The TFTP Server 120 may also include multiple transmitters and multiple receivers (not shown).

The various components of the TFTP Server 120 are operably coupled to one another to provide information transfer. Although a number of separate components are illustrated in FIG. 3, one or more of the components may be combined or commonly implemented. Further, each of the components illustrated in FIG. 3 may be implemented using a plurality of separate elements.

In general, TFTP supports five types of packets, read requests (RRQ), write requests (WRQ), Data (DATA), Acknowledgement (ACK), and Error (ERROR). The RFC 2347 “TFTP Option Extension” provides an extension to TFTP providing an option acknowledgement packet (OACK) to allow for option negotiation between the TFTP client 110 and the TFTP server 120 prior to data (e.g., file) transfer. The TFTP client requests options by transmitting an RRQ or a WRQ packet to the TFTP server. The RRQ/WRQ is appended with an option name and an option value. RFC 3247 adds an option acknowledgement (OACK) packet type to TFTP. The TFTP server replies to the option request by sending an OACK to the client accepting the option, declining the option, or proposing an alternative value for the option. For an RRQ, the TFTP client sends an ACK to the TFTP server to acknowledge the options in the OACK. For a WRQ, the TFTP client sends DATA to the TFTP server to acknowledge the options in the OACK. The TFTP client may also send an ERROR to decline the options. The TFTP client and the TFTP server transfer data according to options agreed upon in the option negotiation. The devices and methods described herein may provide improved TFTP communication by negotiating options for data transfer.

FIG. 4A shows a signal flow diagram 400 of exemplary communication between the TFTP Client 110 and the TFTP Server 120 including a RRQ 401 requesting an unlimited window size option for data transfer. As mentioned above, TFTP typically requires each DATA packet to be acknowledged by an ACK. This configuration may be described as having a transmission “window” size of “1.” However, the RRQ 401 includes a “windowsize” option parameter indicating a request for a window size for data transfer and an option value parameter indicating the specific window size. The RRQ 401 also indicates the requested file to be transferred. The TFTP Client 110 transmits the RRQ 401 to the TFTP Server 120.

In this embodiment, the RRQ 401 includes an option value of “0” for the window size option. A window size of “0” indicates an unlimited window size. As such, the RRQ 401 requests the TFTP Server 120 to transmit an unlimited number of DATA packets to the TFTP Client 110 without requiring an ACK from the TFTP Client 110. That is, the window size is equal to the number of DATA packets needed to transmit the file.

The TFTP Server 120 supports the option of an unlimited window size (e.g., a window size of “0”). Accordingly, the TFTP Server 120 transmits an OACK 402 to the TFTP Client 110. The OACK 402 includes the “windowsize” option parameter and the option value parameter of “0,” thereby accepting the RRQ 401.

The TFTP Client 110 transmits an ACK 403 to the TFTP Server 120 to accept the options for the data transfer. As mentioned above, in other embodiments, the TFTP Server 120 may decline the options or propose alternative options and option values. If the TFTP Client 110 does not accept the TFTP Server's 120 proposed options, the TFTP Client 110 transmits an ERROR to the TFTP Server 120 to decline the options. This process is generally referred to as options negotiation.

In response to receiving the ACK 403, the TFTP Server 120 transmits an unlimited number of DATA packets. Each DATA packet includes blocks of the file requested by the TFTP Client 110. Since the data transfer is performed with an unlimited window size, the TFTP Server 120 will continue to transmit DATA packets without receiving an ACK from the TFTP Client 110. Likewise, the TFTP Client 110 will defer transmitting an ACK to the TFTP Server 110 acknowledging receipt of any DATA until it has received all of the DATA packets for the requested file.

The TFTP Server 120 may need to transmit n blocks of data to transfer the requested file. Accordingly, TFTP Server 120 transmits DATA packets 404-406 to the TFTP Client 110, and continues to transmit DATA packets including the DATA packets 407 and 408 until the TFTP Server 120 has transmitted n DATA packets.

The TFTP Client 110 receives the DATA packet 408. The DATA packet 408 indicates that it is the last data packet. The last DATA packet 408 may indicate that it is the last data packet by having a data field of size “0” or by having a data field of a size that is less than the maximum data field size for the data transfer (e.g., typically 512 bytes long for TFTP unless otherwise agreed to during options negotiation). In response to receiving the last DATA packet 408, the TFTP Client 110 transmits an ACK 409 to the TFTP Server 120. The ACK 409 acknowledges receipt of the n DATA packets transmitted by the TFTP Server 120.

In other embodiments, the windowsize option value may be a specific number. For example, a window size of “4” or “8.” In this case, the TFTP Server 120 will transmit the specified number of DATA packets to the TFTP Client 110 before waiting to receive an ACK from the TFTP Client 110. Upon receiving the ACK, the TFTP Server 120 will continue to transmit the next sequence of DATA packets, up to the window size.

In certain situations, the TFTP Client 110 may not receive at least one DATA packet, due to a network lapse or other issue. In this situation the TFTP Client 110 may transmit an ACK for the last DATA packet it received, indicating the block number of that DATA packet. In this case, the TFTP Server 120 will retransmit the next DATA packet in the sequence. In other embodiments, the TFTP Client 110 may transmit an ACK acknowledging receipt of the last complete window of DATA packets that it received. In this case, the TFTP Server 120 will retransmit the entire window of DATA packets.

FIG. 4B shows a signal flow diagram 410 of exemplary communication between the TFTP Client 110 and the TFTP Server 120 including a WRQ 411 requesting an unlimited window size option for data transfer. The WRQ 411 includes a “windowsize” option parameter indicating a request for a different window size for data transfer and an option value parameter indicating the specific window size. The WRQ 401 also indicates the requested file to be written to. The TFTP Client 110 transmits the WRQ 411 to the TFTP Server 120.

In this embodiment, the WRQ 411 includes an option value of “0” for the window size option. A window size of “0” indicates an unlimited window size. As such, the WRQ 411 requests the TFTP Server 120 to receive an unlimited number of DATA packets from the TFTP Client 110 without transmitting an ACK to the TFTP Client 110.

The TFTP Server 120 supports the option of an unlimited window size (e.g., a window size of “0”). Accordingly, the TFTP Server 120 transmits an OACK 412 to the TFTP Client 110. The OACK 412 includes the “windowsize” option parameter and the option value parameter of “0,” thereby accepting the WRQ 411.

In response to receiving the OACK 412, the TFTP Client 110 transmits the file to the TFTP Server 120 using an unlimited amount of DATA packets without waiting to receive an ACK from the TFTP Server 120. The TFTP Client 120 may need to transmit n blocks of data to transfer the entire file. Accordingly, the TFTP Client transmits n DATA packets, including the DATA packets 413, 414, 415, 416, and 417 to the TFTP Server 120.

The last DATA packet 417 indicates that it is the last DATA packet. The last DATA packet 417 may indicate that it is the last data packet by having a data field of size “0” or by having a data field of a size that is less than the maximum data field size for the data transfer. In response to receiving the last DATA packet 417, the TFTP Server 418 transmits an ACK 418 acknowledging receipt of the n DATA packets 413-417.

Transferring data using TFTP with the unlimited window size provides several advantages. For example, when network communication is reliable, the data throughput may be increased by increasing the window size, since less of the communication is used to acknowledge data. Having an unlimited window size provides the maximum possible data throughput compared to a smaller window size.

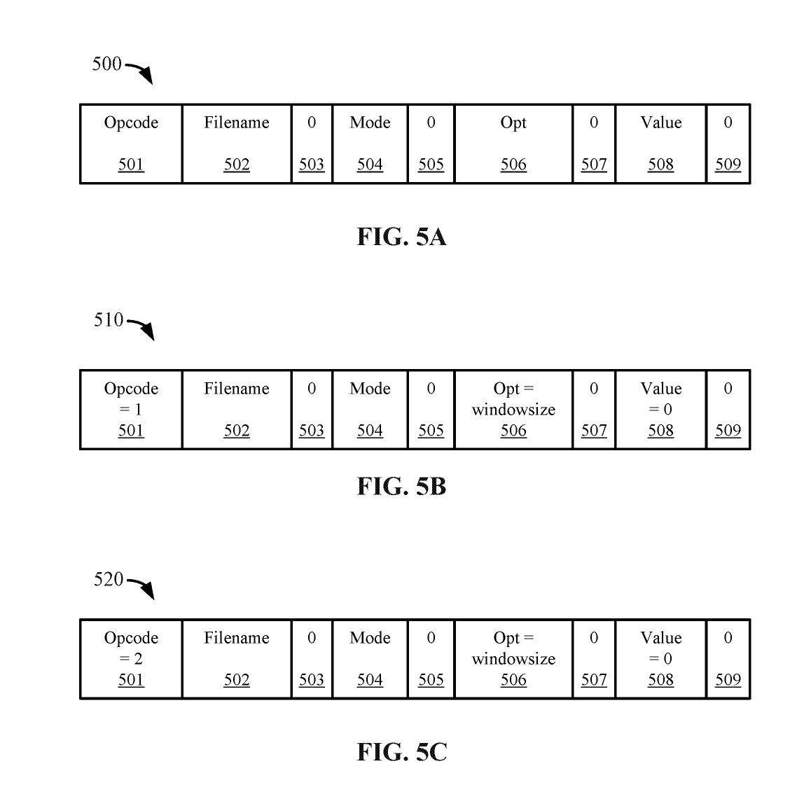

FIG. 5A shows an exemplary TFTP packet 500 for option negotiation. The TFTP packet 500 comprises an Opcode field 501. The Opcode field 501 contains a value from 1-5. A value of “1” indicates an RRQ, a value of “2” indicates a WRQ, a value of “3” indicates DATA, a value of “4” indicates an ACK, and a value of “5” indicates an ERROR.

The TFTP Packet 500 also comprises a Filename field 502. The Filename value 502 includes a value indicating the file to be read or written. The TFTP Packet 500 also comprises a Null Field 503 after the Filename Field 502. The Null Field 503 is 1 byte in length and has a value of “0.” The TFTP Packet 500 also comprises a Mode Field 504. The Mode Field 504 indicates the mode of file transfer. The Mode Field 504 may have a value of “netascii,” indicating that the requests data is formatted as American Standard Code for Information Interchange (ASCII) characters or “octet,” indicating that the requested data is formatted as bytes. The TFTP Packet 500 also comprises another Null Field 505 after the Mode Field 504. The Null Field 505 is 1 byte in length and has a value of “0.”

As mentioned above, the TFTP Packet 500 comprises an Option Field 506. The Option Field 506 contains a value indicating the requested option for the data transfer. The TFTP Packet 500 also comprises another Null Field 507 after the Option Field 506. The Null Field 507 is 1 byte in length and has a value of “0.” The TFTP Packet 500 also comprises an Option Value Field 508. The Option Value Field 508 comprises a value for the option in Option Field 506. The TFTP Packet 500 also comprises another Null Field 509 after the Option Value Field 508. The Null Field 509 is 1 byte in length and has a value of “0.” The TFTP Packet 500 may comprise several pairs of option fields and corresponding option value fields to request numerous options for the data transfer. The fields may be separated by null fields as shown in FIG. 5A.

FIG. 5B shows an exemplary RRQ Packet 510 requesting an unlimited window size option for data transfer. The RRQ Packet 510 is formatted similar to the TFTP Packet 500 except as described below. The Opcode Field 501 of the RRQ 510 has a value of “1,” indicating an RRQ. The Option Field 506 of the RRQ 510 has a value of “windowsize” requesting a window size for data transfer. The Option Value Field 508 has a value of “0” requesting an unlimited window size, as described above.

FIG. 5C shows an exemplary WRQ Packet 520 requesting an unlimited window size option for data transfer. The WRQ Packet 520 is formatted similar to the RRQ Packet 510, except that the Opcode Field 501 has a value of “2,” indicated a WRQ.

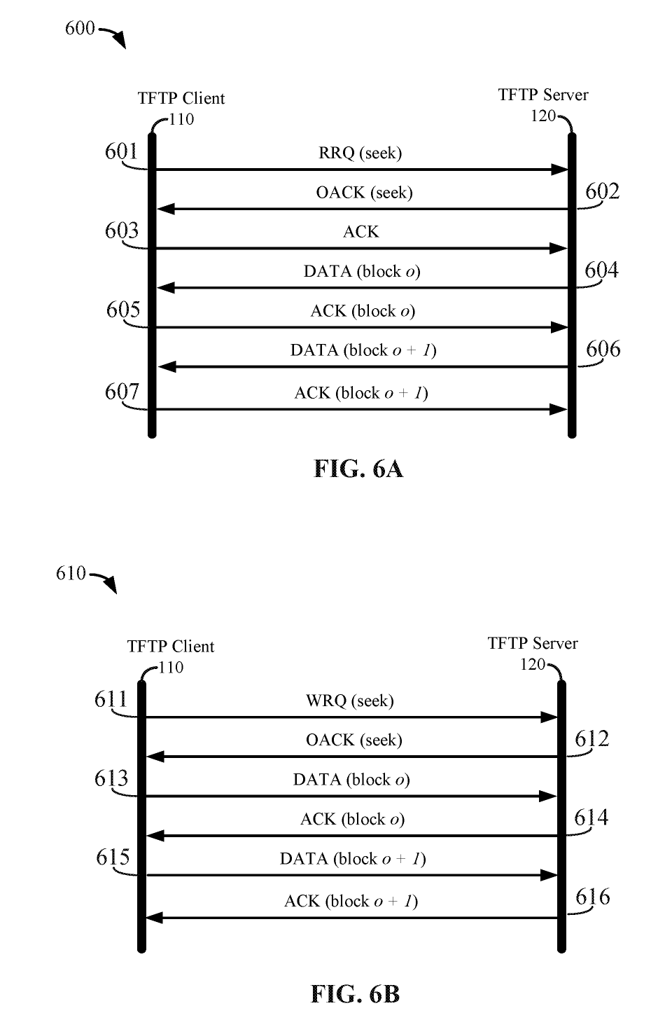

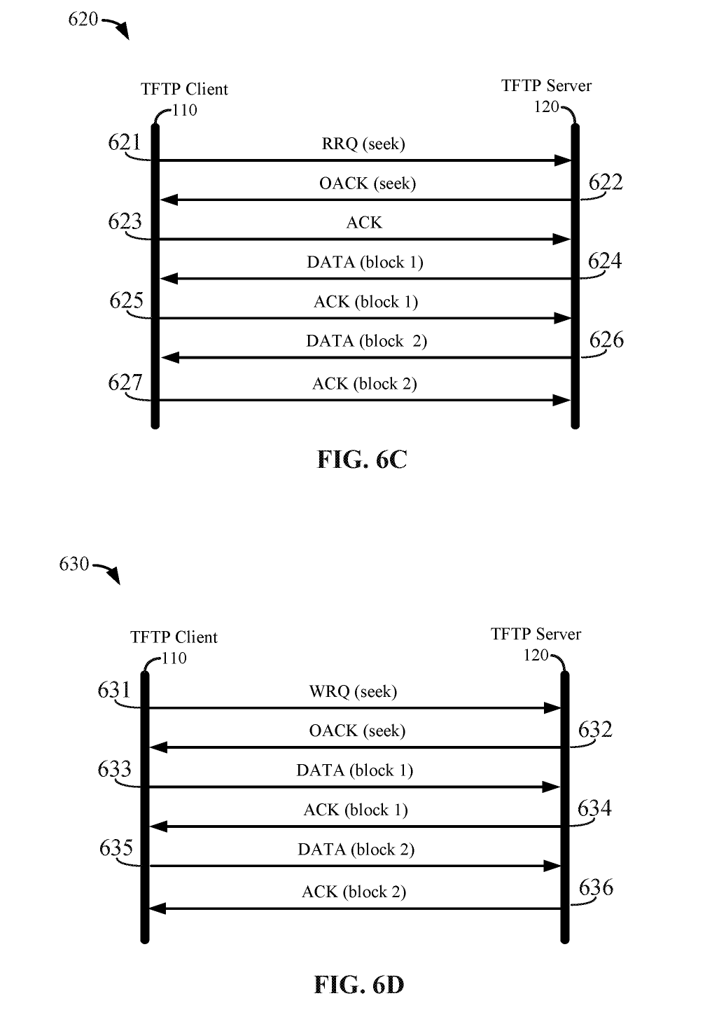

FIG. 6A shows a signal flow diagram 600 of exemplary communication between the TFTP Client 110 and the TFTP Server 120 including an RRQ 601 requesting a seek option for data transfer. The “seek” option includes a value indicating an offset from the beginning of the file for reading or writing. In some embodiments, the value may indicate the offset in bytes. In some other embodiments, the value may be indicated in number of blocks from the beginning of the file. As such, the TFTP Client 110 can read or write a portion of a file. Also, the TFTP Server 120 is configured to not truncate the file during write operations. As such, the portion of the file not written to will remain the same.

The TFTP Client 110 transmits the RRQ 601 to the TFTP Server 120. The RRQ 601 includes the “seek” option. The RRQ 601 also includes an offset value of o (e.g., 8, 64, 1024, or any other suitable number) for the seek option. The TFTP Server 120 supports the seek option and transmits an OACK 602 to the TFTP Client 110. The OACK 602 includes the “seek” option value and offset value of “o,” thereby accepting the RRQ 601.

In response to receiving the OACK 602, the TFTP Client 110 transmits an ACK 603. The ACK 603 accepts the options in the OACK 602. In response to receiving the ACK 603, the TFTP Server 120 transmits a DATA Packet 604 to the TFTP Client 110. The DATA Packet 604 comprises a block of data that is at the offset o from the beginning of the file requested by the TFTP Client 110. Accordingly, the DATA Packet 604 indicates data block o. In response to receiving the DATA Packet 604, the TFTP Client 110 transmits an ACK 605, acknowledging receipt of the DATA Packet 604.

After receiving the ACK 605, the TFTP Server 120 continues data transmission and transmits a DATA Packet 606 to the TFTP Client 110. The DATA Packet 606 comprises the next block of data based on the offset. Accordingly, the DATA Packet 606 indicates data block “o+1.” In response to receiving the DATA Packet 606, the TFTP Client 110 transmits an ACK 607 acknowledging receipt of the DATA packet 606. The ACK 607 indicates the data block “o+1.” The TFTP Server 120 may continue to transmit data accordingly until the file has been transferred.

FIG. 6B shows a signal flow diagram 610 of exemplary communication between the TFTP Client 110 and the TFTP Server 120 including a WRQ 611 requesting a seek option for data transfer. As described above, the “seek” option includes a value indicating an offset from the beginning of the file for reading or writing.

The TFTP Client 110 transmits the WRQ 611 to the TFTP Server 120. The WRQ 611 includes the “seek” option. The WRQ 611 also includes an offset value of o for the seek option. The TFTP Server 120 supports the seek option and transmits an OACK 612 to the TFTP Client 110. The OACK 602 includes the “seek” option value and offset value of “o,” thereby accepting the WRQ 611.

In response to receiving the OACK 612, the TFTP Client 110 transmits a DATA Packet 613 to the TFTP Server 120. The DATA Packet 613 comprises a block of data that is at the offset o from the beginning of the file indicated by the TFTP Client 110 in the WRQ 611. The offset o may indicate to a device receiving the DATA Packet 613 where the block of data included in the packet should be written with respect to the beginning of the file. Accordingly, the DATA Packet 613 indicates data block o. In response to receiving the DATA Packet 613, the TFTP Server 120 transmits an ACK 614, acknowledging receipt of the DATA Packet 613.

After receiving the ACK 614, the TFTP Client 110 continues data transmission and transmits a DATA Packet 615 to the TFTP Server 120. The DATA Packet 615 comprises the next block of data based on the offset. Accordingly, the DATA Packet 615 indicates data block “o+1.” In response to receiving the DATA Packet 615, the TFTP Server 120 transmits an ACK 616 acknowledging receipt of the DATA packet 615. The ACK 616 indicates the data block “o+1.” The TFTP Client 110 may continue to transmit data accordingly until the file has been transferred.

Transferring data using TFTP with the “seek” option provides several advantages. First, the seek option allows for reading files partially. Therefore, the seek option may be used to read portions of a large file. This is advantageous when the file is large compared to when the amount of memory of the TFTP Client 110. In addition, partial reads reduce the amount of time required to transfer data if only a portion of data from the file is needed. For example, the TFTP Client 110 may need to receive only a part of the code from a large Executable and Linkable Format (ELF) file stored on the TFTP Server 120. Also, the TFTP Client 110 may only be capable of loading part of the ELF file in its memory at a time. In this case, the TFTP seek option may be used to read only the portion of the data needed, thereby reducing file transfer time and reducing memory usage.

FIG. 6C shows a signal flow diagram 620 of exemplary communication between the TFTP Client 110 and the TFTP Server 120 including an RRQ 621 requesting a seek option for data transfer. The communication of FIG. 6C is similar to that of FIG. 6A except that the DATA and ACK packets 624-627 indicate block numbers starting at “1” instead of block numbers starting at the offset o. In both FIG. 6A and FIG. 6B, the DATA packets 604, 606 613 and 615 contain data starting from the offset from the beginning of the file.

Referring to FIG. 6C, the TFTP Client 110 transmits the RRQ 621 to the TFTP Server 120. The RRQ 621 includes the “seek” option. The RRQ 621 also includes an offset value of o (e.g., 8, 64, 1024, or any other suitable number) for the seek option. The TFTP Server 120 supports the seek option and transmits an OACK 622 to the TFTP Client 110. The OACK 622 includes a parameter indicating the “seek” option value and offset value of “o,” thereby accepting the RRQ 621.

In response to receiving the OACK 622, the TFTP Client 110 transmits an ACK 623. The ACK 623 accepts the options in the OACK 622. In response to receiving the ACK 623, the TFTP Server 120 transmits a DATA Packet 624 to the TFTP Client 110. The DATA Packet 624 comprises a block of data that is at the offset o from the beginning of the file requested by the TFTP Client 110. The DATA Packet 604 includes a parameter indicating data block 1. In response to receiving the DATA Packet 624, the TFTP Client 110 transmits an ACK 625, acknowledging receipt of the DATA Packet 604. The ACK 625 includes a parameter indicating data block 1.

After receiving the ACK 625, the TFTP Server 120 continues data transmission and transmits a DATA Packet 626 to the TFTP Client 110. The DATA Packet 626 comprises the next block of data based on the offset. Accordingly, the DATA Packet 606 indicates data block 2. In response to receiving the DATA Packet 626, the TFTP Client 110 transmits an ACK 627 acknowledging receipt of the DATA packet 626. The ACK 627 indicates the data block 2. The TFTP Server 120 may continue to transmit data accordingly until the file has been transferred.

FIG. 6D shows a signal flow diagram 630 of exemplary communication between the TFTP Client 110 and the TFTP Server 120 including a WRQ 631 requesting a seek option for data transfer. The communication of FIG. 6D is similar to that of FIG. 6B except that the DATA and ACK packets 633-636 indicate block numbers starting at “1” instead of block numbers starting at the offset o. In both FIG. 6B and FIG. 6D, the DATA packets 633 and 635 contain data starting from the offset from the beginning of the file.

Referring to FIG. 6D, the TFTP Client 110 transmits the WRQ 631 to the TFTP Server 120. The WRQ 631 includes a parameter indicating the “seek” option. The WRQ 631 also includes a parameter indicating an offset value of o for the seek option. The TFTP Server 120 supports the seek option and transmits an OACK 632 to the TFTP Client 110. The OACK 632 includes a parameter indicating the “seek” option value and offset value of “o,” thereby accepting the WRQ 631.

In response to receiving the OACK 632, the TFTP Client 110 transmits a DATA Packet 633 to the TFTP Server 120. The DATA Packet 633 comprises a block of data that is at the offset o from the beginning of the file indicated by the TFTP Client 110 in the WRQ 631. The DATA Packet 633 includes a parameter that indicates data block 1. In response to receiving the DATA Packet 633, the TFTP Server 120 transmits an ACK 634, acknowledging receipt of the DATA Packet 633. The ACK 634 includes a parameter that indicates data block 1.

After receiving the ACK 634, the TFTP Client 110 continues data transmission and transmits a DATA Packet 635 to the TFTP Server 120. The DATA Packet 635 comprises the next block of data based on the offset. The DATA Packet 635 includes a parameter that indicates data block 2. In response to receiving the DATA Packet 635, the TFTP Server 120 transmits an ACK 636 acknowledging receipt of the DATA packet 635. The ACK 636 includes a parameter indicating data block 2. The TFTP Client 110 may continue to transmit data accordingly until the file has been transferred.

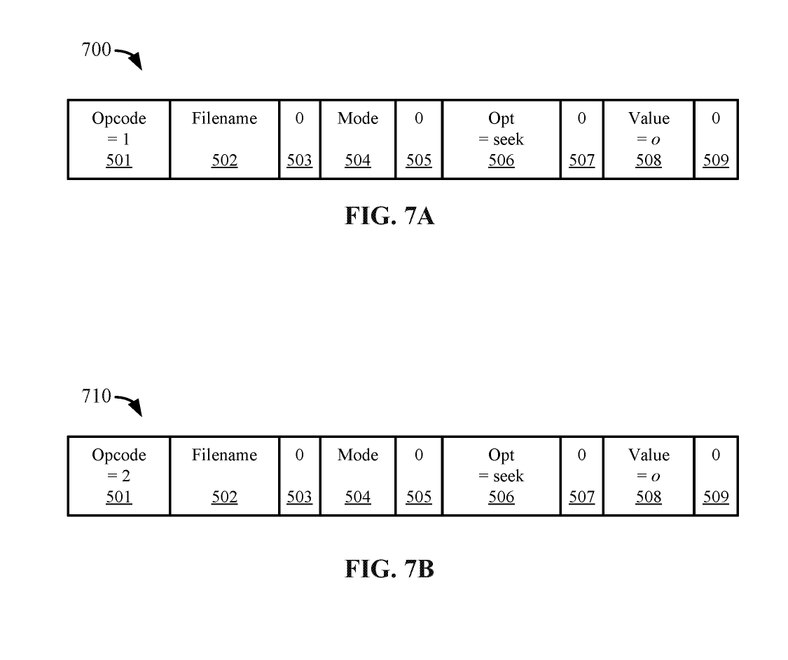

FIG. 7A shows an exemplary RRQ Packet 700 including a seek option for data transfer. The RRQ Packet 700 is formatted similar to the RRQ Packet 510 except as described below. The Option Field 506 of the RRQ Packet 700 includes a value of “seek” requesting a seek option for data transfer. Also, the Option Value Field 508 of the RRQ Packet 700 includes an offset value of “o” indicating the offset (in blocks or bytes) from the beginning of the file for reading.

FIG. 7B shows an exemplary WRQ packet 710 including a seek option for data transfer. The WRQ Packet 710 is formatted similar to the WRQ Packet 520 except as described below. The Option Field 506 of the WRQ Packet 710 includes a value of “seek” requesting a seek option for data transfer. Also, the Option Value Field 508 of the WRQ Packet 710 includes an offset value of “o” indicating the offset (in blocks or bytes) from the beginning of the file for writing.

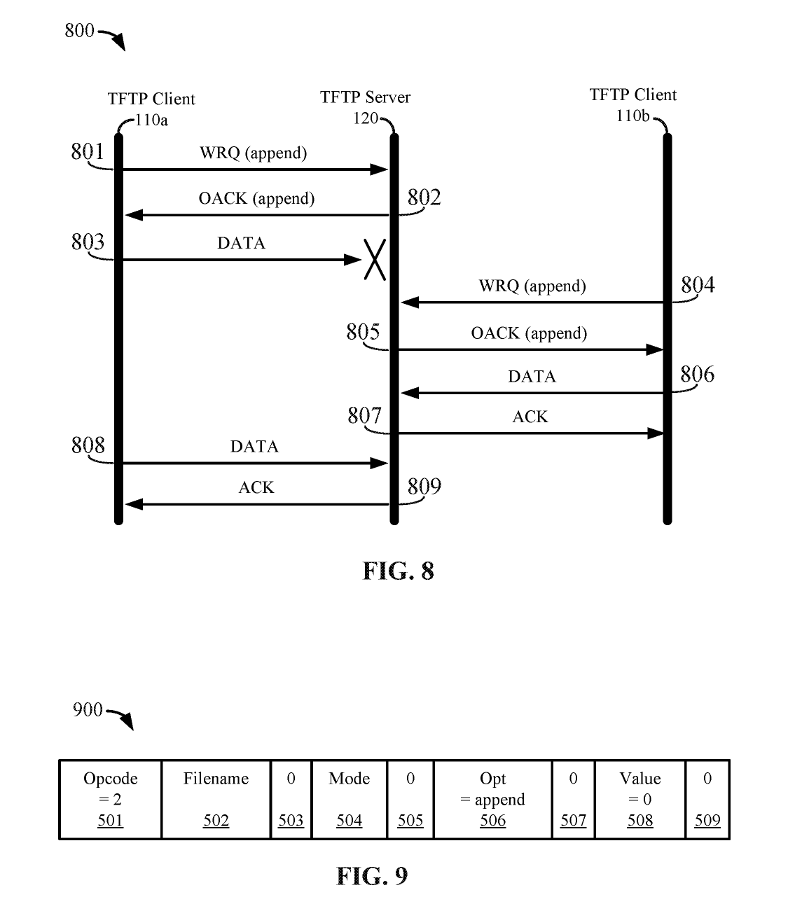

FIG. 8 shows a signal flow diagram of exemplary communication between multiple TFTP Clients 110a and 110b and the TFTP Server 120 including WRQs 801 and 804 requesting an append option for data transfer. The “append” option includes a value instructing the TFTP Server 120 to write data to the end of a file. The “append” option does not require the TFTP Client 110 to know a length of the file. Instead, the TFTP Server 120 is configured to determine the end of the file and further configured to write to the end of the file. As such, the TFTP Server 120 will write data to the end of the file, regardless of any changes to the length of the file. Also, the TFTP Server 120 is configured to not truncate the file during or after write operations. As such, the portion of the file not written to will remain the same.

As shown in FIG. 8, the first TFTP Client 110a transmits the WRQ 801 to the TFTP Server 120. The WRQ 801 includes a value indicating the append option. The WRQ 801 also includes a value indicating a file to be written to. In this embodiment, the TFTP Server 120 supports the append option and accepts the WRQ 801 by transmitting the OACK 802 to the first TFTP Client 110a. The OACK 802 includes a value indicating the append option. In response to receiving the OACK 802, the first TFTP Client 110a transmits the DATA packet 803 to be appended to the end of the file. However, the DATA packet is not received by the TFTP Server 120. The DATA packet 803 may not be received due to a lapse in network connectivity or another network issue. The first TFTP Client 110a waits for an ACK from the TFTP Server 120 acknowledging the DATA Packet 803 before transmitting another DATA packet.

While the first TFTP Client 110a is waiting for an ACK, the second TFTP Client 110b transmits the WRQ 804 to the TFTP Server 120. The WRQ 604 includes a value indicating the append option. The WRQ 804 also includes a value indicates the file that was indicated by the WRQ 801. The TFTP Server 120 accepts the WRQ 804 by transmitting the OACK 805 to the second TFTP Client 110b. The OACK 805 includes a value indicating the append option. In response to receiving the OACK 805, the second TFTP Client 110b transmits the DATA packet 806 to the TFTP Server 120. Upon receiving the DATA packet 806, the TFTP Server 120 transmits an ACK 807 to the second TFTP Client 110b and writes the data in the DATA packet 806 to the end of the file.

After a timeout period, the first TFTP Client 110a will determine that the TFTP Server 120 did not receive the DATA Packet 803 since the first TFTP Client 110a has not received an ACK from the TFTP Server 120 acknowledging the DATA packet 803. Accordingly, the first TFTP Client 110a will retransmit the data in the DATA packet 803. As shown in FIG. 8, the first TFTP Client 110a transmits the DATA Packet 808 to the TFTP Server 120. Upon receiving the DATA packet 808, the TFTP Server 120 transmits an ACK 809 to the first TFTP Client 110a and writes the data in the DATA packet 808 to the end of the file. The TFTP Server 120 is configured to always write to the end of the file when writing with the append option.

Transferring data using TFTP with the “append” option provides several advantages. For example, the TFTP Server 120 will not overwrite data from the second TFTP Client 110b with subsequent data from the TFTP Client 110a. Also, the TFTP Clients 110 do not need to know the length of the file since the TFTP Server 120 is configured to determine the end of the file. The TFTP Client 110a and 110b may use the append option to write a log file to the TFTP Server 120 with minimal overhead. By contrast, TFTP without the append option would require each TFTP Client 110 to read the file, determine the end of the file, write to the end of the file, and then write the appended file back to the TFTP Server 120. Compared to TFTP without this option, the append option provides faster data transfer and also guarantees that the data on the TFTP Server 120 is not overwritten by another TFTP Client 110 writing to the same file.

FIG. 9 shows an exemplary WRQ packet 900 including an append option for data transfer. The WRQ Packet 900 is formatted similar to the WRQ Packet 520 except as described below. The Option Field 506 of the WRQ Packet 900 includes a value of “append” requesting the TFTP Server 120 to append data to an end of the file indicated in the Filename Field 502. Also, the Option Value Field 508 of the WRQ Packet 900 may include a value of “0.” However, the value in the Option Value Field 508 does not change the operation of the TFTP Server 120 since the TFTP Server 120 will always write the data to the end of the file for the “append” option.

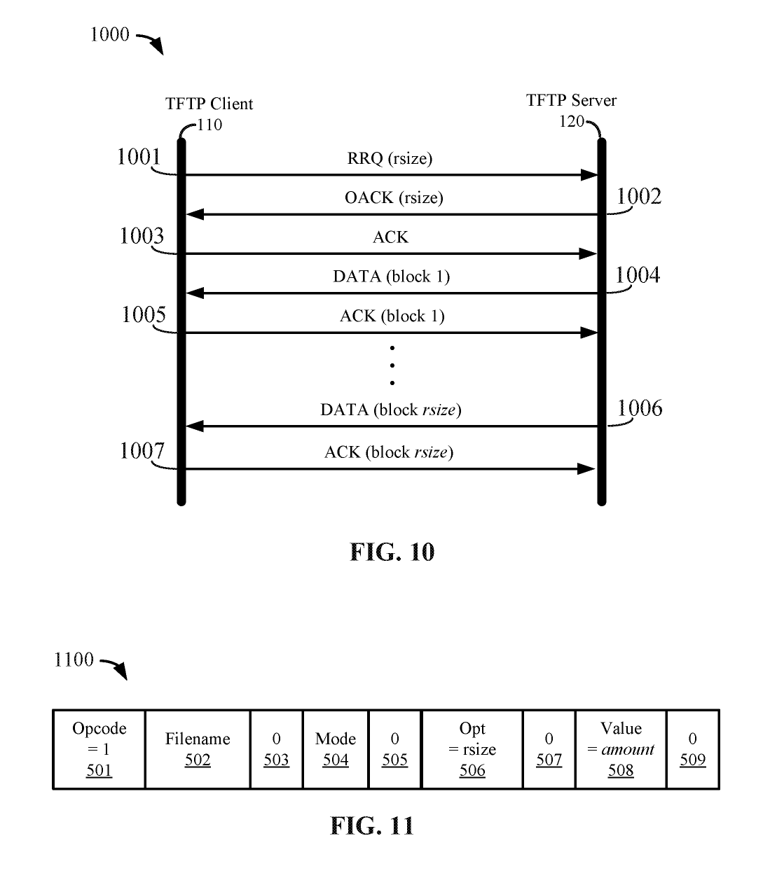

FIG. 10 shows a signal flow diagram 100 of exemplary communication between the TFTP Client 110 and the TFTP Server 120 including an RRQ 1001 requesting an rsize option for data transfer. The “rsize” option includes a value instructing the TFTP Server 120 to limit the amount of data transferred as part of a RRQ and a value indicating the amount of data. Units of the rsize option may be blocks or bytes in various embodiments. The TFTP Server 120 is configured to transmit the amount of data indicated by the “rsize” option. As such, the TFTP Client 110 receives only a portion of the file.

The TFTP Client 110 transmits the RRQ 1001 to the TFTP Server 120. The RRQ 1001 includes a value indicating the “rsize” option. The RRQ 1001 also includes a value indicating the amount of data to be received (e.g., 8, 64, 1024, or any other suitable number). The TFTP Server 120 supports the rsize option and transmits an OACK 1002 to the TFTP Client 110. The OACK 1002 includes the “rsize” option value and amount of data value, thereby accepting the RRQ 1001.

In response to receiving the OACK 1002, the TFTP Client 110 transmits an ACK 1003. The ACK 1003 accepts the options in the OACK 1002. In response to receiving the ACK 1003, the TFTP Server 120 transmits a DATA Packet 1004 to the TFTP Client 110. The DATA Packet 1004 comprises a first block of data from the file indicated in the RRQ 1001. In response to receiving the DATA Packet 1004, the TFTP Client 110 transmits an ACK 1005, acknowledging receipt of the DATA Packet 1004.

Transferring data using TFTP with the “rsize” option provides several advantages. For example, the TFTP Client 110 may transmit an RRQ including both the “seek” option and the “rsize” option to read only a portion of data from the middle of a file. As such, the TFTP Client 110 may quickly read specific data from the TFTP Server 120 compared to TFTP without the “seek” and “rsize” options, which would require reading the entire file. In addition, reading only a portion of the file allows the TFTP Client 110 to dedicate less memory to the read operation.

FIG. 11 shows an exemplary RRQ packet 1100 including an rsize option for the data transfer. The RRQ Packet 1100 is formatted similar to the RRQ Packet 510 except as described below. The Option Field 506 of the RRQ Packet 1100 includes a value of “rsize” (in units of blocks or bytes in various embodiments) instructing the TFTP Server 120 to limit the amount of data transferred as part of a RRQ. Also, the Option Value Field 508 of the RRQ Packet 700 includes a value indicating the amount of data to be transferred.

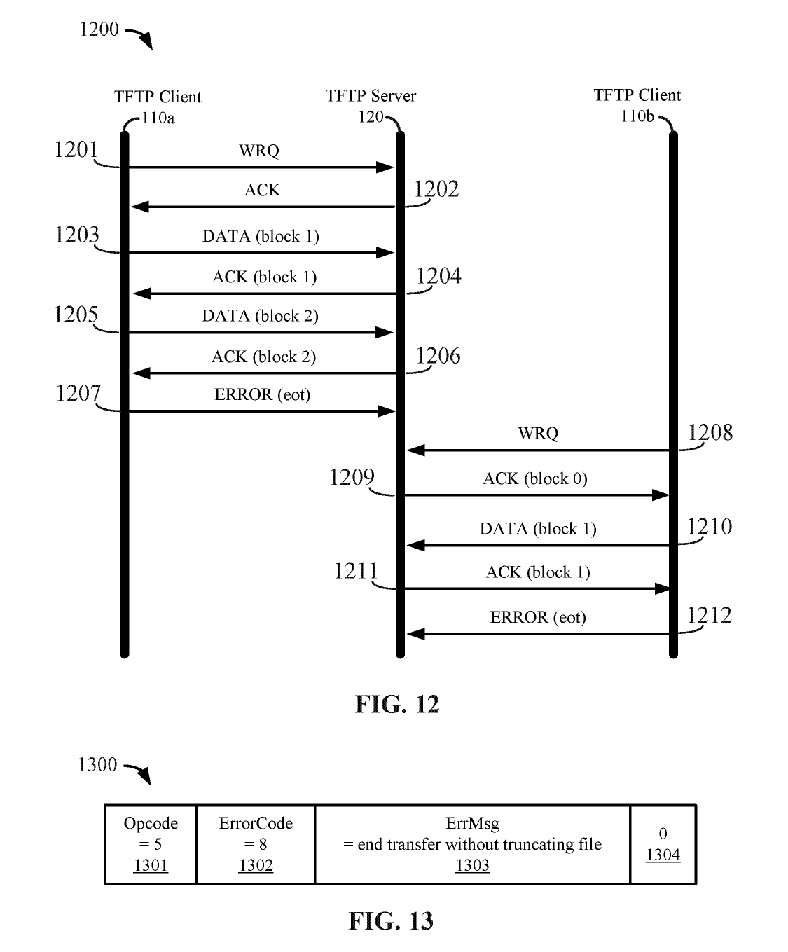

FIG. 12 shows a signal flow diagram 1200 of exemplary communication between multiple TFTP Clients 110a and 110b and the TFTP Server 120 including Error Packets 1207 and 1212 indicating an end of transfer. The Error Packets 1207 and 1212 instruct the TFTP Server 120 to end the file transfer but to not truncate the file. As such, the portion of the file not written to will remain the same.

The first TFTP Client 110a transmits a WRQ 1201 to the TFTP Server 120. The TFTP Server 120 transmits an ACK 1202 to acknowledge the WRQ 1201. In response to receiving the ACK 1202, the first TFTP Client 110a transmits a DATA Packet 1203. The TFTP Server 120 receives the DATA Packet 1203 and writes data to a first data block. The TFTP Server 120 transmits an ACK 1204 to acknowledge the DATA Packet 1203. In response, the first TFTP Client 110a transmits the DATA Packet 1205. The TFTP Server 120 receives the DATA Packet 1205 and writes data to a second data block. The TFTP Server 120 transmits an ACK 1206 to acknowledge the DATA Packet 1207. In this embodiment, the first TFTP Client 110a does not have more data to transmit to the TFTP Server 120. However, the first TFTP Client 110a may not want to truncate the file that it was writing to. Accordingly, the first TFTP Client 110a transmits the ERROR Packet 1207 indicating an end of transfer and instructing the TFTP Server 120 to not truncate the file.

Later, the second TFTP Client 110b transmits a WRQ 1208 to the TFTP Server 120. The WRQ 1208 indicates the same file written to by the first TFTP Client 110a. The TFTP Server 120 transmits an ACK 1209 to acknowledge the WRQ 1208. In response to receiving the ACK 1209, the second TFTP Client 110b transmits a DATA Packet 1210. The TFTP Server 120 receives the DATA Packet 1210 and writes data to the first data block. The TFTP Server 120 transmits an ACK 1211 to acknowledge the DATA Packet 1210. In this embodiment, the second TFTP Client 110b does not have more data to transmit to the TFTP Server 120. However, the second TFTP Client 110b may not want to truncate the file that it was writing to. That is, the second TFTP Client 110b wants the file to retain the second data block of the file that the TFTP Server 120 wrote in response to receiving the DATA Packet 1205 from the first TFTP Client 110a. Accordingly, the second TFTP Client 110b transmits the ERROR Packet 1212 indicating an end of transfer and instructing the TFTP Server 120 to not truncate the file. Accordingly, the file contains the first block of data based on the DATA Packet 1210 received from the second TFTP Client 110b and the second block of data based on the DATA Packet 1205 received from the first TFTP Client 110a.

Ending a TFTP write operation using the “end of transfer” ERROR Packet provides several advantages. For example, the TFTP Client 110 may transmit a WRQ including the “seek” option to write data to the middle of a file. However, the TFTP Client 110 want to only write to a portion of the file and it may want to keep the rest of the file intact. Accordingly, the TFTP Client 110 may write specific data to the TFTP Server 120 using the “seek” and then quickly end the write operation using the “end of transfer” ERROR Packet. Using the “seek” option and the “end of transfer” ERROR Packet takes less time than not using these options, which would require reading the file from the TFTP Server, writing to the middle of the file, and then writing the file back to the TFTP Server 120. In addition, writing to only a portion of the file allows the TFTP Client 110 to dedicate less memory to the write operation.

FIG. 13 shows an exemplary Error Packet 1300 indicating an end of transfer. The Error Packet 1300 comprises an Opcode Field 1301. The Opcode Field 1301 includes a value indicating that the packet is an ERROR packet. The Error Packet 1300 also comprises an ErrorCode Field 1302. The ErrorCode Field 1302 includes a value indicating the end of a file transfer. For example, the value of the ErrorCode Field 1302 may be “8.” The Error Packet 1300 also comprises an ErrMsg Field 1303. The ErrMsg Field 1303 includes a human-readable string value indicating the end of the file transfer. The Error Packet 1300 also comprises a 1-byte Null Field 1304 including a value of “0.”

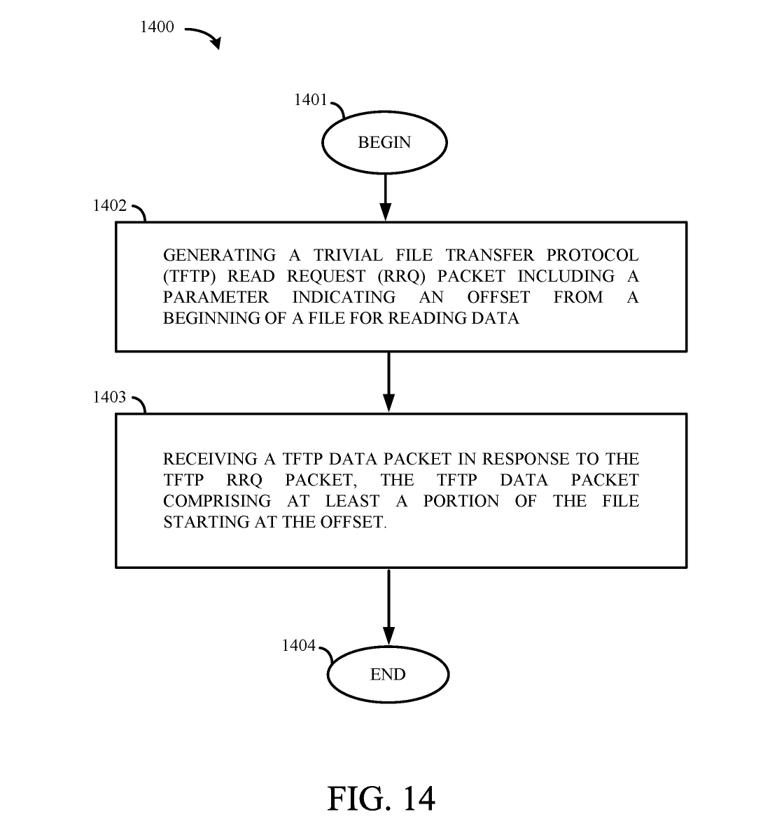

FIG. 14 shows a flow chart 1400 of an exemplary method for TFTP file transfer by the TFTP Client 110. At step 1401, the method for TFTP file transfer begins. At step 1402, the TFTP Client 110 generates a TFTP RRQ including a parameter indicating an offset from a beginning of a file for reading data. At step 1403, the TFTP Client 110 receives a TFTP data packet in response to the TFTP RRQ packet. The TFTP data packet comprises at least a portion of the file starting at the offset. At step 1404 the method for TFTP file transfer ends.

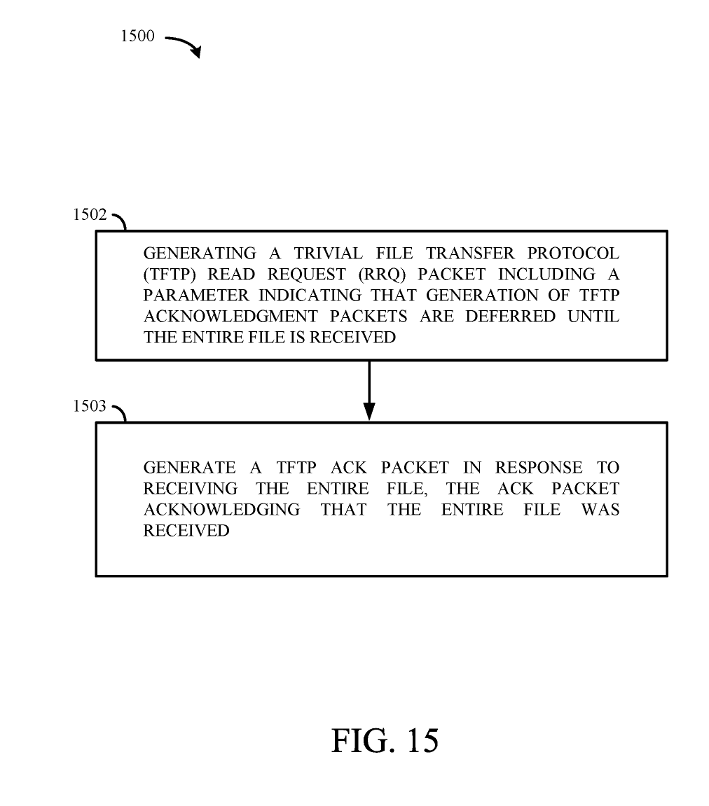

FIG. 15 shows a flow chart 1500 of an exemplary method for TFTP file transfer by the TFTP Client 110. In some aspects, the process 1400 may be performed by the device 120. For example, in some aspects, instructions stored in the memory 202 may configure the processor 201 to perform one or more of the functions discussed below with respect to FIG. 15. In some aspects, process 1500 may be utilized to transfer data between two separate devices (such as devices 110 and 120) over a network. In some other aspects, process 1500 may be utilized to transfer data between two hardware processors within a single physical device, for example, over a bus internal to the device.

Block 1502 generates a trivial file transfer protocol (TFTP) read request (RRQ) packet requesting transfer of a first file. The RRQ packet includes a parameter indicating that generation of TFTP acknowledgment packets are deferred until the entire first file is received. Generating the RRQ packet may include, in some embodiments, transmitting the RRQ packet over a wired or wireless network to a physically separate device. For example, generating the RRQ packet may include transmitting the packet on a local area network or wide area network in some aspects. In other aspects, generating the RRQ packet may include generating signals on a data bus within a single device to communicate the RRQ packet to a second electronic hardware processor within the same physical device.

Some aspects of block 1502 may also generate a Trivial File Transfer Protocol (TFTP) Write Request (WRQ) packet requesting transfer of a second file, the WRQ packet including a second parameter indicating that generation of TFTP acknowledgement (ACK) packets are deferred until the entire second file is received. In some aspects, generating a packet includes transmitting the packet over a computer network, such as a local area network or wireless network. In some aspects, generating a packet may include transmitting the packet over an internal data bus within a device, for example, the packet may be sent from a first hardware processor to a second hardware processor an internal data bus of a device.

In some aspects, block 1502 may generate and/or transmit one or more of the read request (RRQ) and write request (WRQ) discussed above. The transmission may be performed in some aspects, by the transmitter 303.

In block 1503, a TFTP acknowledgment packet is generated in response to receiving the entire first file. For example, in some aspects, block 1503 may only generate a TFTP acknowledgment packet upon reception of an end of file indication (EOF), such as a “−1” character in glibc or Ctrl+Z in Microsoft Windows environments. In some aspects, the parameter discussed above with respect to block 1502 indicates that TFTP acknowledgments should be deferred until receipt of the entire file, regardless of a size of the file. Thus, in these aspects, generation of TFTP acknowledgements is not based on a number of packets including file data that are generated, or based on an amount of file data generated, but instead are based on generation of all the file data. Thus, in some aspects, generation of any TFTP ACK packet relating to the transfer of the file may be performed only in response to receipt of all of the file data.

Some aspects of process 1500 that generate the write request discussed above may also generate the entire second file before waiting for a TFTP ACK packet for second file data in response to the second parameter. After the second file is generated (for example, transmitted to a separate device or signaled over an internal data bus), process 1500 may wait for a TFTP ACK packet. If no TFTP ACK packet is received within a threshold period of time, some aspects of process 1500 may generate an error signal, such as an error code or error message. Some aspects of process 1500 may instead retransmit the entire second file if no acknowledgment is received within the threshold period of time.

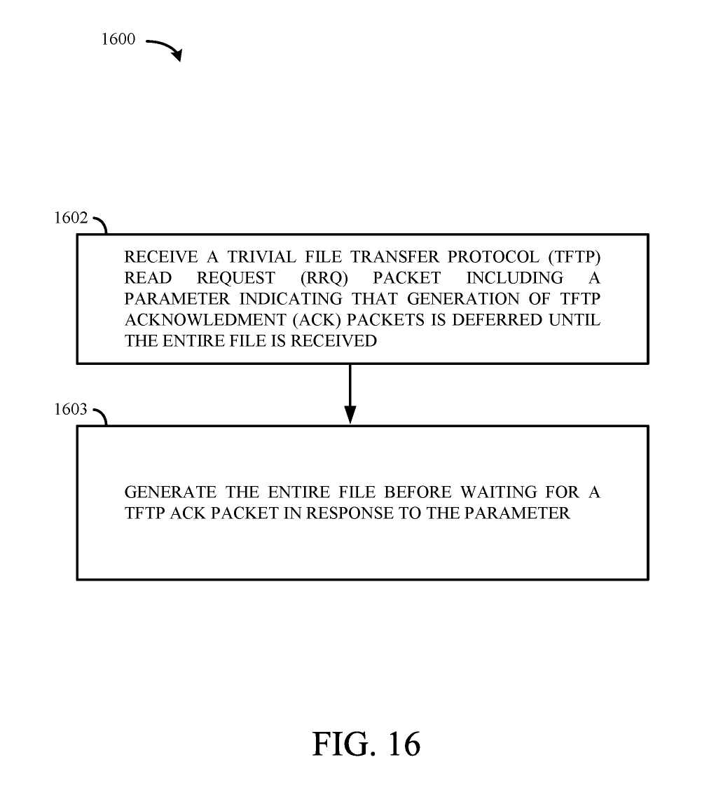

FIG. 16 shows a flow chart 1600 of an exemplary method for data transfer by the TFTP Server 120. In some aspects, the process 1600 may be performed by the device 110. In some aspects, instructions stored in the memory 302 may configure the processor 301 to perform one or more of the functions discussed below with respect to FIG. 16. In some aspects, process 1600 may be utilized to transfer data between two separate devices over a network (such as devices 110 and 120). In some other aspects, process 1600 may be utilized to transfer data between two hardware processors within a single physical device, for example, over a bus internal to the device.

In block 1602, a Trivial File Transfer Protocol (TFTP) Read Request (RRQ) packet requesting transfer of a file is received. The RRQ packet includes a parameter indicating that generation of TFTP acknowledgement (ACK) packets are deferred until the entire file is received. In some aspects, the packet may be received from a computer network, such a wireless network or a local area network by a physically separate device. For example, in some aspects, the receiver 304 may be configured to receive the RRQ packet. In some other aspects, the packet may be received over a data bus from another electronic hardware processor within one physical device. In these aspects, the processor 301 may be configured to receive the packet from the data bus.

In block 1603, the entire file is generated before waiting for a TFTP ACK packet in response to the parameter. In some aspects, generation of acknowledgments is deferred regardless of the size of the file. In other words, a number of received packets or a number of received data blocks is irrelevant to transmission of generation of acknowledgments in some aspects. Thus, in some aspects, no TFTP acknowledgment packets for the file are generated until the entire file is received by the receiving side, regardless of the number of received data blocks and/or the number of received packets. Thus, block 1603 does not wait for acknowledgments before generating and/or transmitting the entire file. By generating the entire file before waiting for an acknowledgment, block 1603 does not delay generation of any portion of the file based on whether an acknowledgment for any portion of the file's data has been received.

In some aspects, generating the entire file may include transmitting packets including data for the entire file over a network to a node performing the other side of the TFTP file transfer. For example, the entire file may be transmitted over a local area network, wide area network, or wireless network. In some aspects, generating the entire file may include transferring data for the entire file over a data bus within a single device from a first electronic hardware processor to a second electronic hardware processor, which receives the entire file. In these aspects, the second electronic hardware processor may be configured to generate an acknowledgment upon receiving the entire file.

Some aspects, of process 1600 include receiving a Trivial File Transfer Protocol (TFTP) Write Request (WRQ) packet requesting transfer of a second file. The WRQ packet may include a second parameter indicating that generation of TFTP acknowledgement (ACK) packets are deferred until the entire second file is received. For example, the second parameter may indicate that acknowledgments are deferred until receipt of the entire file, regardless of a size of the file. These aspects of process 1600 also generate a TFTP ACK packet in response to receiving the entire file. The second parameter does not indicate a number of data blocks or a number of packets that represent a threshold after which, an acknowledgment is received. Thus, no matter how many data blocks or how many packets the file may comprise, the second parameter indicates that acknowledgments are deferred until the entire second file is received. In other words, an acknowledgment is only sent after the entire second file is received.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like. Further, a “channel width” as used herein may encompass or may also be referred to as a bandwidth in certain aspects.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Thus, in some aspects computer readable medium may comprise non-transitory computer readable medium (e.g., tangible media). In addition, in some aspects computer readable medium may comprise transitory computer readable medium (e.g., a signal). Combinations of the above should also be included within the scope of computer-readable media.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

What is claimed is:

1. A device for data transfer, comprising:
an electronic hardware processor configured to generate a Trivial File Transfer Protocol (TFTP) Read Request (RRQ) packet requesting transfer of a file, the RRQ packet including a parameter indicating that transmission of TFTP acknowledgement (ACK) packets are deferred until the electronic hardware processor receives the entire file,
wherein the electronic hardware processor is further configured to generate a TFTP ACK packet in response to receiving the entire file.

2. The device of claim 1, wherein the electronic hardware processor is further configured to generate a Trivial File Transfer Protocol (TFTP) Write Request (WRQ) packet requesting transfer of a second file, the WRQ packet including a second parameter indicating that generation of TFTP acknowledgement (ACK) packets are deferred until the entire second file is received, wherein the electronic hardware processor is further configured to generate the entire second file before waiting for a TFTP acknowledgement packet.

3. The device of claim 1, wherein the parameter indicates TFTP acknowledgments should be deferred until receipt of the entire file, regardless of a size of the file.

4. The device of claim 3, wherein the parameter does not indicate a number of received data blocks or a number of received packets before a TFTP acknowledgment may be transmitted.

5. The device of claim 1, wherein the electronic hardware processor is further configure to generate any TFTP ACK packet for the file only in response to receiving the entire file.

6. The device of claim 1, further comprising a second electronic hardware processor, configured to receive the Trivial File Transfer Protocol (TFTP) Read Request (RRQ) packet requesting transfer of a file, the RRQ packet including the parameter, wherein the second electronic hardware processor is further configured to generate the entire file before waiting for a TFTP ACK packet in response to the parameter.

7. The device of claim 1, further comprising a transmitter configured to transmit the RRQ packet.

8. A device for data transfer, comprising:
an electronic hardware processor configured to receive a Trivial File Transfer Protocol (TFTP) Read Request (RRQ) packet requesting transfer of a file, the RRQ packet including a parameter indicating that generation of TFTP acknowledgement (ACK) packets are deferred until the entire file is received, wherein the electronic hardware processor is further configured to generate the entire file before waiting for a TFTP ACK packet in response to the parameter.

9. The device of claim 8, wherein the electronic hardware processor is further configured to receive a Trivial File Transfer Protocol (TFTP) Write Request (WRQ) packet requesting transfer of a second file, the WRQ packet including a second parameter indicating that generation of TFTP acknowledgement (ACK) packets are deferred until the entire second file is received, wherein the electronic hardware processor is further configured to, in response to the second parameter, generate a TFTP ACK packet is response to receiving the entire file.

10. The device of claim 9, wherein the second parameter indicates TFTP acknowledgments should be deferred until receipt of the entire file, regardless of a size of the file.

11. The device of claim 10, wherein the second parameter does not indicate a number of received data blocks or a number of received packets before a TFTP acknowledgment may be transmitted.

12. The device of claim 9, wherein the electronic hardware processor is further configure to generate any TFTP ACK packet for the second file only in response to receiving the entire second file in response to the second parameter.

13. The device of claim 8, further comprising a receiver configured to receive the RRQ packet.

14. The device of claim 8, comprising:
a second electronic hardware processor configured to generate the Trivial File Transfer Protocol (TFTP) Read Request (RRQ) packet requesting transfer of a file, the RRQ packet including the parameter, wherein the second electronic hardware processor is further configured to defer generation of the TFTP ACK packet until the entire file is received.

15. A method for data transfer, comprising:
generating, by an electronic hardware processor, a Trivial File Transfer Protocol (TFTP) Read Request (RRQ) packet requesting transfer of a file, the RRQ packet including a parameter indicating that transmission of TFTP acknowledgement (ACK) packets are deferred until the entire file is received; and
generating, by the electronic hardware processor, a TFTP ACK packet in response to receiving the entire file.

16. The method of claim 15, further comprising:
generating a Trivial File Transfer Protocol (TFTP) Write Request (WRQ) packet requesting transfer of a second file, the WRQ packet including a second parameter indicating that generation of TFTP acknowledgement (ACK) packets are deferred until the entire second file is received; and
generating the entire second file before waiting for a TFTP acknowledgement packet.

17. The method of claim 15, wherein the parameter indicates TFTP acknowledgments should be deferred until receipt of the entire file, regardless of a size of the file.

18. The method of claim 15, wherein the parameter does not indicate a number of received data blocks or a number of received packets before a TFTP acknowledgment may be transmitted.

19. The method of claim 15, further comprising generating, by the electronic hardware processor, any TFTP ACK packet for the file only in response to receiving the entire file.

20. The method of claim 15, further comprising:
receiving, by a second electronic hardware processor, the Trivial File Transfer Protocol (TFTP) Read Request (RRQ) packet requesting transfer of a file, the RRQ packet including the parameter; and
generating, by the second electronic hardware processor, the entire file before waiting for a TFTP ACK packet is response to the parameter.

21. A method for data transfer, comprising:
receiving, by an electronic hardware processor, a Trivial File Transfer Protocol (TFTP) Read Request (RRQ) packet requesting transfer of a file, the RRQ packet including a parameter indicating that generation of TFTP acknowledgement (ACK) packets are deferred until the entire file is received, and
generating, by the electronic hardware processor, the entire file before waiting for a TFTP ACK packet in response to the parameter.

22. The method of claim 21, further comprising:
receiving, by the electronic hardware processor, a Trivial File Transfer Protocol (TFTP) Write Request (WRQ) packet requesting transfer of a second file, the WRQ packet including a second parameter indicating that generation of TFTP acknowledgement (ACK) packets are deferred until the entire second file is received; and
in response to the second parameter, generating, by the electronic hardware processor, a TFTP ACK packet is response to receiving the entire file.

23. The method of claim 22, wherein the second parameter indicates TFTP acknowledgments should be deferred until receipt of the entire file, regardless of a size of the file.

24. The method of claim 23, wherein the second parameter does not indicate a number of received data blocks or a number of received packets before a TFTP acknowledgment may be transmitted.

25. The method of claim 22, further comprising generating, by the electronic hardware processor, any TFTP ACK packet for the second file only in response to receiving the entire second file in response to the second parameter.

26. The method of claim 21, further comprising:
generating, by a second electronic hardware processor, the Trivial File Transfer Protocol (TFTP) Read Request (RRQ) packet requesting transfer of the file, the RRQ packet including the parameter; and
deferring generation, by the second electronic hardware processor, of the TFTP ACK packet until the entire file is received in response to the parameter.
